(19) United States
(12) Patent Application Publication
(10) Pub. No.: US 2019/0380362 A1
(43) Pub. Date: Dec. 19, 2019

(54) DISPENSING SYSTEMS FOR NATURALLY CARBONATED SOFT DRINKS

(71) Applicant: The Coca-Cola Company, Atlanta, GA (US)

(72) Inventors: Arthur G. RUDICK, Ormond Beach, FL (US); Susan R. W. LANE, Kennesaw, GA (US); Jessica Anne LESAGONICZ, Atlanta, GA (US)

(21) Appl. No.: 16/490,718

(22) PCT Filed: Mar. 1, 2018
(86) PCT No.: PCT/US18/20434

§ 371 Date: Sep. 3, 2019

Related U.S. Application Data
(60) Provisional application No. 62/465,961, filed on Mar. 2, 2017.

(51) Int. Cl. A23L 2/38; B67D 1/12; B67D 1/00; B67D 1/08; A23L 2/54

(52) U.S. Cl. CPC A23L 2/382; B67D 1/1252; B67D 1/0009; A23V 2002/00; A23L 2/54; B67D 2210/00118; B67D 1/0888

(57) ABSTRACT

The present application provides a beverage dispensing system for naturally carbonated beverages. The beverage dispensing system may include a cabinet with a cooling element and a heating element and a fermentation vessel positioned within the cabinet. The cooling element and the heating element maintain the fermentation vessel within a temperature range for a fermentation process therein and the cooling element cools the fermentation vessel to stop the fermentation process.

### TECHNICAL FIELD

The present application and the resultant patent relate generally to beverage dispensing system and more particularly relate to beverage dispensing systems capable of producing and dispensing naturally carbonated soft drinks and other types of beverages.

### BACKGROUND OF THE INVENTION

Current post-mix beverage dispensing systems generally mix streams of syrup, concentrate, sweetener, bonus flavors, other types of flavorings, and/or other ingredients with carbonated or still water or other types of diluents. The carbonated water may be produced in a conventional carbonator in which compressed carbon dioxide is introduced in the water stream.

Consumers are expressing an increasing preference for natural ingredients. For example, a beverage made from pure juice, water, and sugar that has been carbonated by a natural fermentation process may be the ultimate natural beverage experience. Consumers are also expressing an increasing preference for craft beverages. A naturally carbonated soft drink would fit well into the craft category. There is thus a desire for a safe, controlled, and semi-automated process that produces consistent naturally carbonated soft drinks and other types of beverages.

There is a temperature range that is optimal for fermentation. As long as the temperature is within the optimal range, fermentation will occur. If the initial temperature happens to be within the optimal range then fermentation will start all by itself and no temperature modification is required. If the temperature gets too hot, the yeast may begin to die. Therefore if the temperature exceeds the optimal range, then cooling may be required to get the temperature back to the optimal range. If the temperature drops below the optimal range, then fermentation may slow down or stop. Therefore if the temperature drops below the optimal range, then heating may be required to get the temperature back to the optimal range.

### SUMMARY OF THE INVENTION

The present application and the resultant patent thus provide a beverage dispensing system for naturally carbonated beverages. The beverage dispensing system may include a cabinet with a cooling element and a heating element and a fermentation vessel positioned within the cabinet. The cooling element and the heating element maintain the fermentation vessel within a temperature range for a fermentation process therein and the cooling element cools the fermentation vessel to stop the fermentation process.

The present application and the resultant patent further provide a method of producing a beverage with natural carbonation. The method may include the steps of placing a sugar containing liquid in a fermentation vessel, maintaining the fermentation vessel within a temperature range until the pressure therein reaches a predetermined level, cooling the fermentation vessel, and dispensing the beverage from the fermentation vessel.

The present application and the resultant patent further provide a beverage dispensing system for naturally carbonated beverages. The beverage dispensing system may include a cabinet with a cooling element and a heating element and a fermentation vessel positioned within the cabinet. A pressure switch may be in communication with the fermentation vessel. The cooling element and the heating element maintain the fermentation vessel within a temperature range for a fermentation process therein until the pressure within the fermentation vessel reaches a predetermined level as determined by the pressure switch and the cooling element cools the fermentation vessel to stop the fermentation process.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a beverage dispensing system as may be described herein.

FIG. 2 is a sectional view of the beverage dispensing system of FIG. 1.

FIG. 3 is a perspective view of an alternative embodiment of a beverage dispensing system as may be described herein.

FIG. 4 is a sectional view of the beverage dispensing system of FIG. 3.

### DETAILED DESCRIPTION

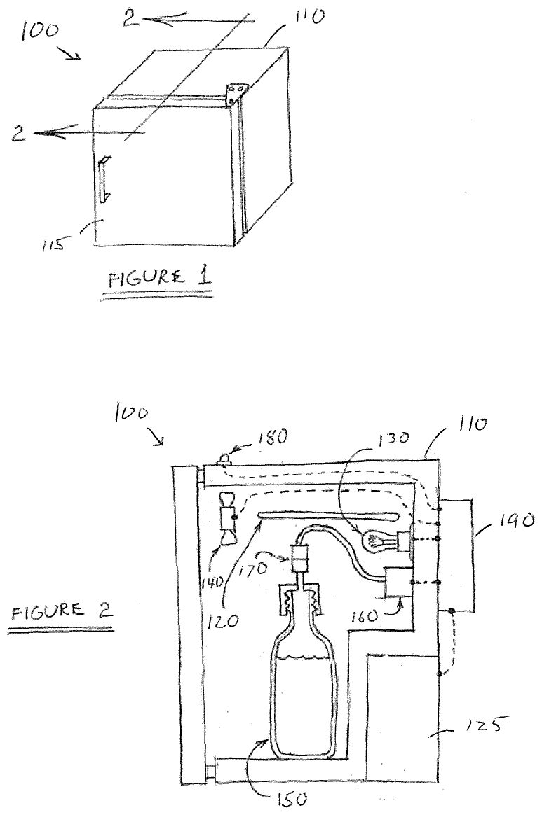

Referring now to the drawings, in which like numerals refer to like elements throughout the several views, FIGS. 1 and 2 show an example of a beverage dispensing system 100 as may be described herein. The beverage dispensing system 100 may include an insulated cabinet 110. The insulated cabinet 110 may have any suitable size, shape, or configuration. The insulated cabinet 110 may be enclosed by a door 115. The insulated cabinet 110 may contain a cooling element 120. For example, the cooling element 120 may be an evaporator of a Rankine cycle refrigeration system 125. Other types of conventional refrigeration methods also may be used. The cabinet 110 also may contain a heating element 130. For example, the heating element 130 may be a lightbulb, a heating mat, a resistance wire, and the like. Other type of conventional heating methods also may be used. The interior of the insulated cabinet 110 may include an air circulation device 140. For example, the air circulation device 140 may be a fan and the like. Circulating the air inside the insulated cabinet 110 may eliminate local hot and/or cold spots and may improve the overall efficiency of the heating and cooling. Other types of conventional air movement methods also may be used. Other components and other configurations may be used herein

The beverage dispensing system 100 may include a fermentation vessel 150. The fermentation vessel 150 may be located within the insulated cabinet 110. The fermentation vessel 150 may have any suitable size, shape, or configuration. The fermentation vessel 150 may be made out of a pressure resistant material such as stainless steel, glass, disposable plastic, reusable plastic, and the like. The fermentation vessel 150 may have a threaded finish and may be sealed by a threaded closure. Other types of closures may be used herein.

The beverage dispensing system 100 may include a pressure switch 160 in communication with the fermentation vessel 150. The pressure switch 150 may shut off the heating element 130 and turn on the cooling element 120 when the pressure inside of the fermentation vessel 150 reaches a pre-set pressure as will be described in more detail below. The pressure switch 160 may be of conventional design. The pressure switch 160 may have an intermediate quick disconnect 170 attached to the fermentation vessel 150. The quick disconnect 170 may have a shut-off feature such that the internal pressure in the fermentation vessel 150 may be maintained even in a disconnected state. The quick disconnect 170 may be of conventional design. The beverage dispensing system 100 may include an indicator 180 on the insulated cabinet 110 or elsewhere to indicate to operational status and/or other types of parameters. The indicator 180 may include a light, multiple lights, a buzzer, an LCD display, and the like. Other types of indication methods may be used herein.

Overall operation of the beverage dispensing system 100 may be governed by a controller 190. The controller 190 may be any type of programmable logic device with conventional input devices, output devices, memory, operating systems, and communication systems. The controller 190 may be local or remote. Any number of controllers 190 may be used herein. Other components and other configurations may be used herein.

In use, the fermentation vessel 150 may be loaded with a sugar containing liquid and yeast. For example, the sugar containing liquid may be pure juice; water mixed with juice; or water, sugar, and flavoring. The sugar may be cane sugar, beet sugar, high fructose corn syrup, honey, or mixtures thereof. The sugar containing liquid may have a brix ranging from about 10 to about 15. The yeast may be champagne yeast and the like. Other types of ingredients may be used herein. The contents of the fermentation vessel 150 may be made from a pre-set recipe designed to produce proper results when used in conjunction with the beverage dispensing system 100.

When the fermentation vessel 150 has been placed into the insulated cabinet 110 and the door 115 is closed, the heating element 130 or the cooling element 120 may be activated to maintain the internal temperature of the insulated cabinet 110 at a level that supports optimum fermentation. This temperature may be, for example, between about seventy-five (75° F.) and about eighty-five degrees Fahrenheit (85° F.) (about 23.9° C. to about 29.4° C.). Over time, as fermentation progresses and as carbon dioxide is produced, the carbonation level builds within the beverage. As fermentation continues, the pressure will continue to increase inside the fermentation vessel 150.

The pre-set pressure may correspond to a desired level of carbonation in the beverage. For example, if two volumes of carbonation are desired, and the internal temperature of the insulated cabinet 110 is about eighty degrees Fahrenheit (80° F.) (about 26.7° C.), then the pre-set pressure may be about twenty-six pounds per square inch (26 psi) (about 1.8 Kg/cm²). At this point, the pressure switch 150 and the controller 190 may turn off the heating element 130 and turn on the cooling element 120. Other types of triggers may be used herein. The fermentation time may range between about four (4) to about twenty-four (24) hours depending on multiple factors such as temperature and/or product attributes. When the cooling element 120 turns on, the fermentation vessel 150 may cool, for example, to about thirty-six degrees Fahrenheit (36° F.) (about 2.2° C.). At such a temperature, the fermentation process will stop and the beverage may be ready for consumption.

When the beverage is ready to drink, the insulated cabinet 110 may be opened and the fermentation vessel 150 may be disconnected via the quick-disconnect 170. The fermentation vessel 150 may be removed from the insulated cabinet 110 then subsequently opened and the beverage may be poured into the consumer's cup directly from the fermentation vessel 110.

The recipe, level of carbonation, and pre-set pressure may be selected so as to produce the desired level of carbonation without exceeding a maximum allowable alcohol limit. The maximum allowable alcohol limit may be, for example, about 0.5%. The fermentation vessel 150 may be filled with an amount of liquid that minimizes the headspace in the fermentation vessel 150 so as to cause the pressure in the vessel to build up quickly thus producing the desired pressure and therefore the desired level of carbonation before too much alcohol is produced. The pressure switch 160 may contain a pressure relief valve (not shown) to make sure that the pressure in the system does not exceed a safe level in the event that a failure prevents the insulated cabinet 110 from being chilled and fermentation proceeds unchecked. Other components and other configurations may be used herein.

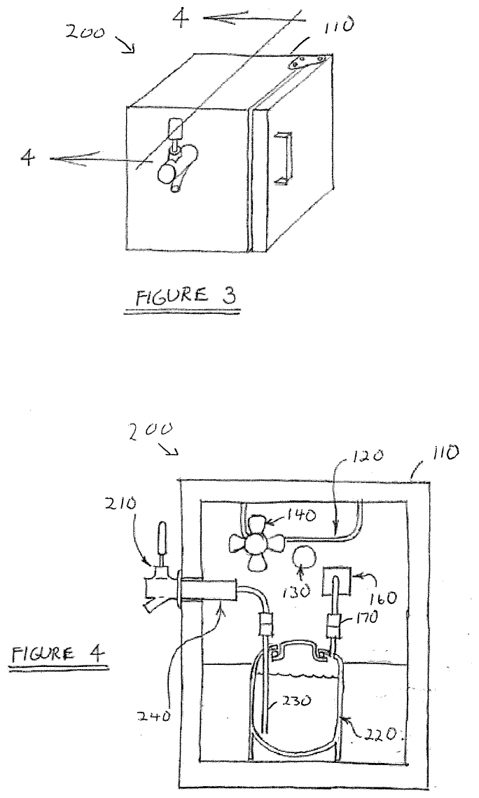

FIGS. 3 and 4 show an example of a second embodiment of a beverage dispensing system 200 as may be described herein. The beverage dispensing system 100 may include the insulated cabinet 110, the cooling element 120, the heating element 130, the air circulation device 140, the controller 190, and other components largely similar to those described above. The beverage may be poured into the consumer's cup from a tap 210 which may be located on the side of the insulated cabinet 110. The tap 210 may be of conventional design.

In this example, the fermentation vessel 150 may be a fermentation tank 220 that may hold a volume of a beverage that is too large to be decanted conveniently by hand. The fermentation tank 220 may be made of a pressure resistant material such as stainless steel and the like. The fermentation tank 220 may be keg-like in shape and/or may have any suitable size, shape, or configuration. The headspace of the fermentation tank 220 may be connected to the pressure switch 160 in a manner similar to that shown above. The fermentation tank 220 may contain a dip tube 230 and the like connected to a pressure reduction device 240 and subsequently to the tap 210. The pressure reduction device 240 may be of conventional design. (A combination pressure reduction device and tap is commercially available in the form of a pre-mix valve.) The carbon dioxide pressure in the fermentation tank 220 may push the beverage out through the pressure reduction device 240 and through the tap 210. The fermentation tank 220 may have a number of quick disconnects 170 in the lines going to the tap 210 and the pressure switch 160 to allow the fermentation tank 220 to be removed from the insulated cabinet 110 for cleaning. The fermentation tank 220 also may have a removable lid so as to allow ingredients to be loaded into the fermentation tank 220 and to allow the interior of the fermentation tank 220 to be cleaned. Other components and other configurations may be used herein.

The beverage dispensing systems 100, 200 described herein thus produce a beverage that fits well with the consumer's desires for natural and craft beverages. Moreover, the “theatrical” aspect surrounding the “brewing” of the beverage may create a beverage experience for which a consumer may be willing to pay a premium price. The process produces an adequately carbonated beverage without creating enough alcohol to prevent the beverage from being classified as a soft drink. Specifically, the purpose of the fermentation process is to carbonate the beverage rather than to produce alcohol. The fermentation process is controlled by sensing the pressure inside the closed fermentation vessel 150. The fermentation process is stopped by chilling the fermentation vessel in response to the vessel pressure reaching a pre-set value. A pasteurization step also may be added. Delivery of the beverage may be refrigerated.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A beverage dispensing system for naturally carbonated beverages, comprising:
a cabinet;
the cabinet comprising a cooling element and a heating element; and
a fermentation vessel positioned within the cabinet;
wherein the cooling element and the heating element maintain the fermentation vessel within a temperature range for a fermentation process therein and wherein the cooling element cools the fermentation vessel to stop the fermentation process.

2. The beverage dispensing system of claim 1, wherein the cabinet comprises an air circulation device therein.

3. The beverage dispensing system of claim 1, further comprising a pressure switch in communication with fermentation vessel.

4. The beverage dispensing system of claim 3, further comprising a controller in communication with the pressure switch and wherein the controller turns off the heating element and turns on the cooling element when the pressure within the fermentation vessel reaches a predetermined level.

5. The beverage dispensing system of claim 4, further comprising an indicator in communication with the controller.

6. The beverage dispensing system of claim 1, wherein the fermentation vessel comprises a quick disconnect thereon.

7. The beverage dispensing system of claim 1, wherein the fermentation vessel comprises a fermentation tank.

8. The beverage dispensing system of claim 7, wherein the fermentation tank comprises a dip tube therein.

9. The beverage dispensing system of claim 7, wherein the fermentation tank comprises a tap in communication therewith.

10. The beverage dispensing system of claim 7, wherein the fermentation tank comprises a pressure reducing device in communication therewith.

11. The beverage dispensing system of claim 1, further comprising a plurality of fermentation vessels.

12. The beverage dispensing system of claim 1, wherein the fermentation vessel comprises a steel, a glass, or a thermoplastic.

13. The beverage dispensing system of claim 1, wherein the heating element and the cooling element maintain the cabinet from about seventy-five (75° F.) to about eighty-five (85° F.) degrees Fahrenheit (about 23.9° C. to about 29.4° C.).

14. The beverage dispensing system of claim 1, wherein the cooling element may cool the cabinet to about thirty-six (36° F.) degrees Fahrenheit (about 2.2° C.).

15. A method of producing a beverage with natural carbonation, comprising:
placing a sugar containing liquid in a fermentation vessel;
maintaining the fermentation vessel within a temperature range until the pressure therein reaches a predetermined level;
cooling the fermentation vessel; and
dispensing the beverage from the fermentation vessel.
